(19) United States
(12) Patent Application Publication
(10) Pub. No.: US 2014/0370379 A1
(43) Pub. Date: Dec. 18, 2014

(54) SECONDARY BATTERY AND MANUFACTURING METHOD THEREOF

(71) Applicant: SEMICONDUCTOR ENERGY LABORATORY CO., LTD., Atsugi-shi (JP)

(72) Inventors: Nobuhiro INOUE, Isehara (JP); Junpei MOMO, Sagamihara (JP); Ryota TAJIMA, Isehara (JP); Naoki KURIHARA, Atsugi (JP)

(73) Assignee: SEMICONDUCTOR ENERGY LABORATORY CO., LTD., Atsugi-shi (JP)

(21) Appl. No.: 14/294,481

(22) Filed: Jun. 3, 2014

(30) Foreign Application Priority Data
Jun. 14, 2013 (JP) 2013-125428

(51) Int. Cl. H01M 4/36

(52) U.S. Cl. CPC H01M 4/364
USPC 429/213

(57) ABSTRACT

To increase the capacity and energy density of a secondary battery by using a novel material as a material for a negative electrode in order to increase the amount of lithium ions transferred in charge and discharge. In the case where the negative electrode includes a current collector and a negative electrode active material layer, gallium is used as the negative electrode active material, and the negative electrode active material layer contains resin at 2 wt % or more, preferably 10 wt % or more, adhesion between the current collector and the negative electrode active material can be increased. This inhibits separation between the current collector and the negative electrode active material due repeated expansion and contraction, resulting in longer lifetime of the secondary battery.

### BACKGROUND OF THE INVENTION

1. Field of the Invention

The present invention relates to a structure of a secondary battery and a method for fabricating the secondary battery. In particular, the present invention relates to an electrode of a lithium-ion secondary battery.

2. Description of the Related Art

Examples of the secondary battery include a nickel-metal hydride battery and a lithium-ion secondary battery.

Such secondary batteries are used as power sources in portable information terminals typified by mobile phones. In particular, lithium-ion secondary batteries have been actively researched and developed because the capacity thereof can be increased and the size thereof can be reduced.

Electrodes serving as positive electrodes or negative electrodes of lithium-ion secondary batteries are each formed using, for example, lithium metal, a carbon-based material, or an alloy material.

The lithium-ion secondary battery using a group of whiskers including silicon has been disclosed in Patent Document 1.

### REFERENCE

### [Patent Document 1]

Japanese Published Patent Application No. 2012-018919

### SUMMARY OF THE INVENTION

Lithium-ion secondary batteries used for portable information terminals have a problem of deteriorating in a short period because of, for example, repeated charge and discharge cycles and overcharge. The lifetime of secondary batteries is shortened over time and by the number of times of charge. Accordingly, the time during which users can use portable information terminals when they are away from home is shortened. This imposes inconvenience on the users.

If secondary batteries in portable information terminals are less likely to deteriorate and have sufficiently long lifetime, users can freely carry and use the portable information terminals without inconvenience.

A method for increasing the lifetime of secondary batteries is to improve the structures or materials of, for example, positive electrodes and negative electrodes.

The existing lithium-ion secondary batteries have higher capacity than other secondary batteries; however, the capacity of the lithium-ion secondary batteries is not enough yet. Thus, for example, portable information terminals having limitation on allowable volume are required to be frequently charged, which is inconvenient for users.

An increase in the capacity of lithium-ion secondary batteries means an increase in charge and discharge capacity of the batteries even without a change in volume. Therefore, the capacity increase allows users to use portable information terminals without concern for remaining battery level.

Here, an object is to increase the capacity and energy density of a secondary battery by using a novel material as a material for a negative electrode in order to increase the amount of lithium ions transferred in charge and discharge.

Another object is to provide a secondary battery having increased charge and discharge capacity and high initial charge efficiency.

Negative electrode materials using silicon or tin are actively developed. In the case of using such a material for a negative electrode, however, for example, repeated charge and discharge cycles cause expansion or contraction, and the repeated expansion or contraction damages an active material layer, promoting deterioration of a secondary battery. Moreover, the repeated expansion or contraction might cause separation between the current collector and the active material layer.

To inhibit deterioration due to such expansion or contraction, a material that can be alloyed with lithium and becomes in a liquid state is used for a negative electrode. In the case where a negative electrode includes a current collector and a negative electrode active material layer, gallium, which is a material having a low melting point (melting point: 29.7° C.), is used as a material of a negative electrode active material and is mixed with a fibrous body or resin so that gallium can be on a surface of the electrode even when it becomes in a liquid state. The resin or fibrous body surrounding gallium is solid and functions as a structural body for maintaining a shape or a cushioning even when gallium becomes in a liquid state.

An embodiment of the invention disclosed in this specification is a secondary battery including a positive electrode and a negative electrode. The negative electrode includes a current collector and a negative electrode active material layer. The negative electrode active material layer contains gallium and resin.

When the negative electrode active material layer contains resin at 2 wt % or more, preferably 10 wt % or more, adhesion between the current collector and a negative electrode active material can be increased. This inhibits separation between the current collector and the negative electrode active material due repeated expansion and contraction, resulting in longer lifetime of the secondary battery.

Specifically, gallium powder (less than 98 wt %) and fluorine resin (2 wt % or more) are stirred to form slurry and the slurry is applied to the current collector, so that the negative electrode is formed. Examples of fluorine resin include poly(vinylidene fluoride) and polytetrafluoroethylene.

Another embodiment of the invention disclosed in this specification is a secondary battery including a positive electrode and a negative electrode. The negative electrode includes a current collector and a negative electrode active material layer. The negative electrode active material layer contains gallium, resin, and a fibrous body. When the fibrous body is used and gallium is retained in the fibrous body, the secondary battery can be fabricated smoothly.

A material used for the negative electrode is not limited to a simple substance of gallium, and a low-melting-point gallium alloy that can be alloyed with lithium may be used. The gallium alloy refers to an alloy containing gallium, for example, a gallium alloy containing indium and/or tin.

The use of gallium for a negative electrode of a secondary battery leads to fabrication of a lithium-ion secondary battery that achieves not only high charge and discharge capacity but also improved initial charge and discharge efficiency.

### BRIEF DESCRIPTION OF THE DRAWINGS

In the accompanying drawings:

FIG. 1A is a cross section image of a negative electrode of one embodiment of the present invention, and FIG. 1B is a schematic diagram thereof;

FIGS. 2A to 2C show the charge and discharge characteristics of a lithium-ion secondary battery of one embodiment of the present invention;

FIG. 3 is a conceptual diagram illustrating the state of charging a lithium-ion secondary battery of one embodiment of the present invention;

FIG. 4 is a conceptual diagram illustrating the state of discharging the lithium-ion secondary battery of one embodiment of the present invention;

FIGS. 5A to 5C illustrate a coin-type secondary battery;

FIG. 6 illustrates a laminated secondary battery;

FIGS. 7A and 7B illustrate a cylindrical secondary battery; and

FIG. 8 illustrates an example of a cross-sectional structure of a coin-type secondary battery.

### DETAILED DESCRIPTION OF THE INVENTION

Embodiments of the present invention will be described below in detail with reference to the drawings. However, the present invention is not limited to the descriptions below, and it is easily understood by those skilled in the art that modes and details disclosed herein can be modified in various ways. Furthermore, the present invention is not construed as being limited to the descriptions of the embodiments.

### Embodiment 1

First, a procedure for forming an electrode containing gallium is as follows.

Gallium powder is mixed with a solvent and resin, and the mixture is applied to a current collector 10. In this embodiment, copper foil is used as the current collector, and the mixture ratio of gallium to resin (PVDF) is 90:10.

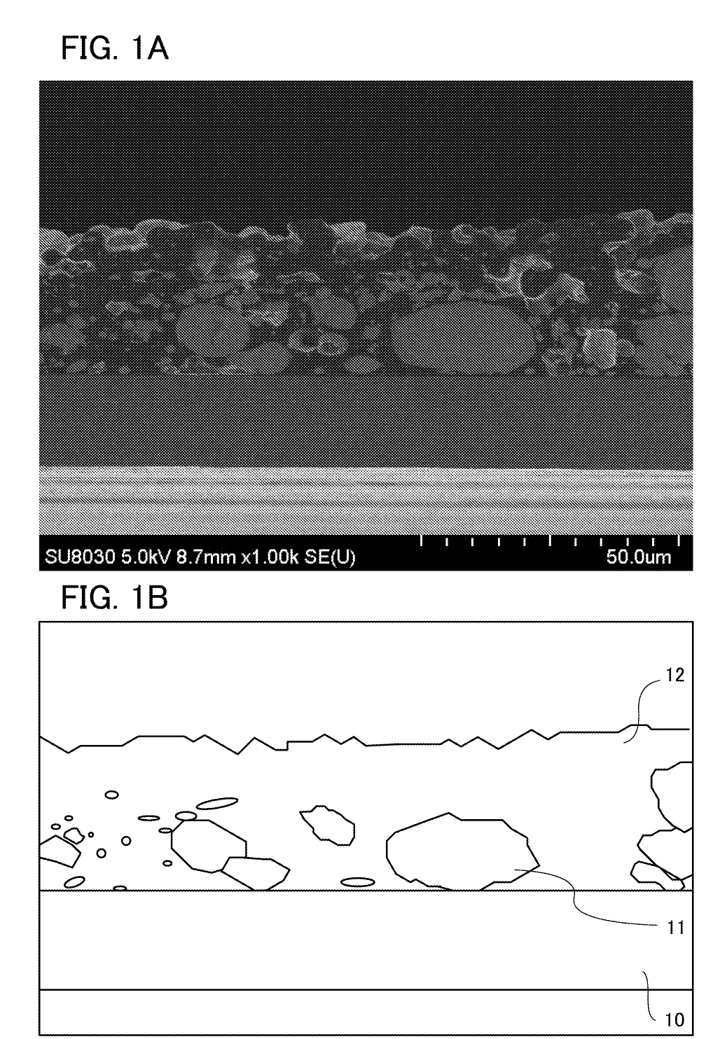

FIG. 1A is a cross section SEM image, and FIG. 1B is a schematic diagram thereof. In FIG. 1B, reference numerals 11 and 12 denote gallium and a layer containing resin, respectively.

Samples each with a resin proportion of 2 wt %, samples each with a resin proportion of 5 wt %, and samples each with a resin proportion of 10 wt % are prepared. The samples with the same proportion are formed at different temperatures: room temperature and 40° C. The samples are wiped off with paper to examine whether they have adhesion with copper foil. A comparative example sample does not contain resin, that is, has a resin proportion of 0 wt % and contains only gallium. Table 1 shows the results.

TABLE 1

PVDF
proportion
(wt %)

| | 0% | 2% | 5% | 10% |
|---|---|---|---|---|
| Room | ∘ | ∘ | ∘ | ∘ |
| temperature | | | | |
| 40° C. | x | Δ | Δ | ∘ |

Note that in Table 1, a cross “x” represents the state where a surface of the copper foil is exposed when the sample is wiped off with paper, a triangle “Δ” represents the state where a trace left when the sample is wiped off with paper can be recognized, and a circle “∘” represents the state where the sample is not changed when it is wiped off with paper.

As shown in Table 1, all the samples formed at room temperature do not have any problem. However, the surface of the copper foil is exposed when the comparative example sample with a resin proportion of 0 wt % formed at 40° C. is wiped off with paper. In the cases of the samples formed at 40° C., resin contained at 2 wt % or more, preferably at 10 wt % or more increases adhesion with copper foil.

Next, a half cell is fabricated using an electrode containing gallium, and the charge and discharge characteristics of a lithium-ion secondary battery are measured. Note that in the measurement of the half cell, gallium evaluated as a negative electrode active material is used for a positive electrode, and metal lithium is used for a negative electrode.

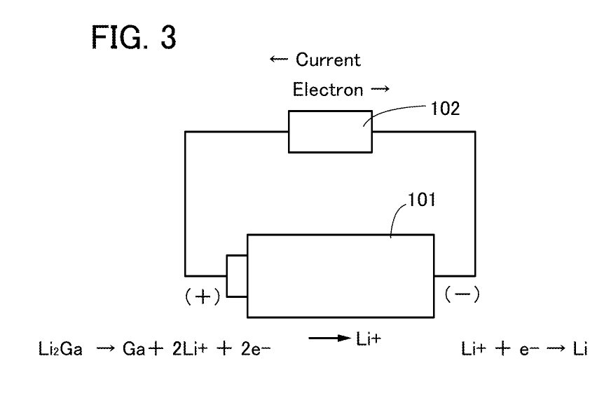

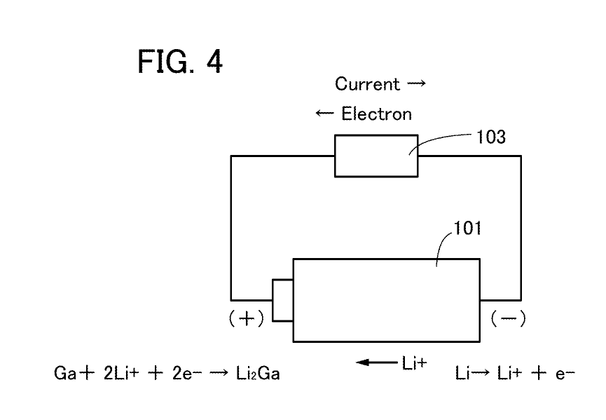

FIG. 3 illustrates the case of charging a half cell of a lithium-ion secondary battery, and FIG. 4 illustrates the case of discharging the half cell of the lithium-ion secondary battery.

FIG. 3 illustrates the connection between a lithium-ion secondary battery 101 and a charger 102 when charging is performed. In charging the lithium-ion secondary battery, a reaction expressed by Formula (1) occurs in the positive electrode through an alloy phase depending on the ratio of lithium to gallium.

Li₂Ga→Ga+2Li⁺+2e⁻ (1)

A reaction of Formula (2) occurs in the negative electrode.

Li⁺+e⁻→Li (2)

FIG. 4 illustrates the connection between the lithium-ion secondary battery 101 and a load 103 when discharging is performed. In discharging the lithium-ion secondary battery, a reaction expressed by Formula (3) depending on the ratio of lithium to gallium occurs in the positive electrode.

Ga+2Li⁺+2e⁻→Li₂Ga (3)

A reaction of Formula (4) occurs in the negative electrode.

Li→Li⁺+e⁻ (4)

A procedure for fabricating the half cell is as follows.

First, gallium powder and PVDF resin are dissolved in NMP (N-methyl-2-pyrrolidone), which is a polar solvent, and they are mixed to form slurry. The slurry is applied to a current collector and then is dried. Note that a surface of the current collector is subjected to undercoating in advance.

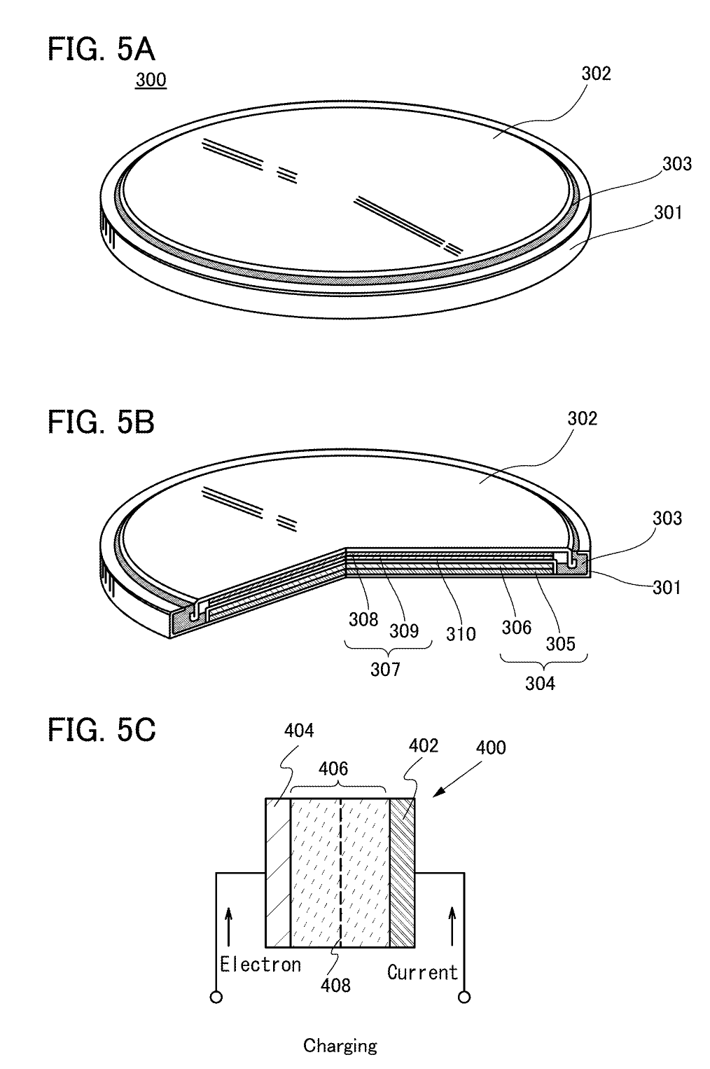

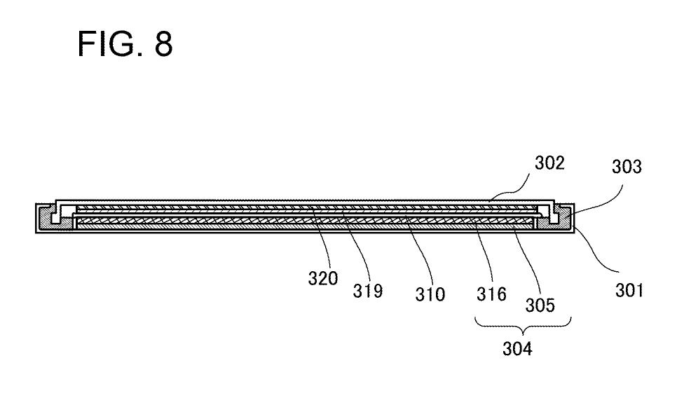

Furthermore, cellulose fiber may be put on slurry so that a fibrous body of the cellulose fiber is impregnated with gallium in a liquid state. FIG. 8 illustrates a structural example of a coin-type storage battery including a fibrous body. Note that FIG. 8 is a cross-sectional view of a half cell. A schematic view of the coin-type storage battery is illustrated in FIG. 5B. In FIG. 8, the same portions are denoted by the same reference numerals. The half cell includes lithium foil 319, a conductive plate 320 (or a combination of a conductive plate and a washer) provided over the lithium foil 319 so as to fix the lithium foil 319, and a negative electrode can 302 provided over the conductive plate 320. The half cell further includes, over a positive electrode can 301, copper foil as a positive electrode current collector and a fibrous body 316 formed in such a manner that slurry that is formed by mixing gallium, PVDF, and NMP is applied to the copper foil and cellulose fiber is provided over the slurry so that the cellulose fiber is impregnated with gallium. The fibrous body 316 serves as an active material layer. A separator 310 is provided over and in contact with the fibrous body 316, and the lithium foil 319 is provided over and in contact with the separator 310.

Lithium metal is used as a negative electrode and a space between a positive electrode and the negative electrode is filled with an electrolytic solution, so that the half cell is fabricated. Note that the electrolytic solution is formed by dissolving LiPF₆ as a salt in a mixed solution containing ethylene carbonate (EC) and diethyl carbonate (DEC), which are aprotic organic solvents, at a volume ratio of 3:7. As the separator, polypropylene (PP) is used.

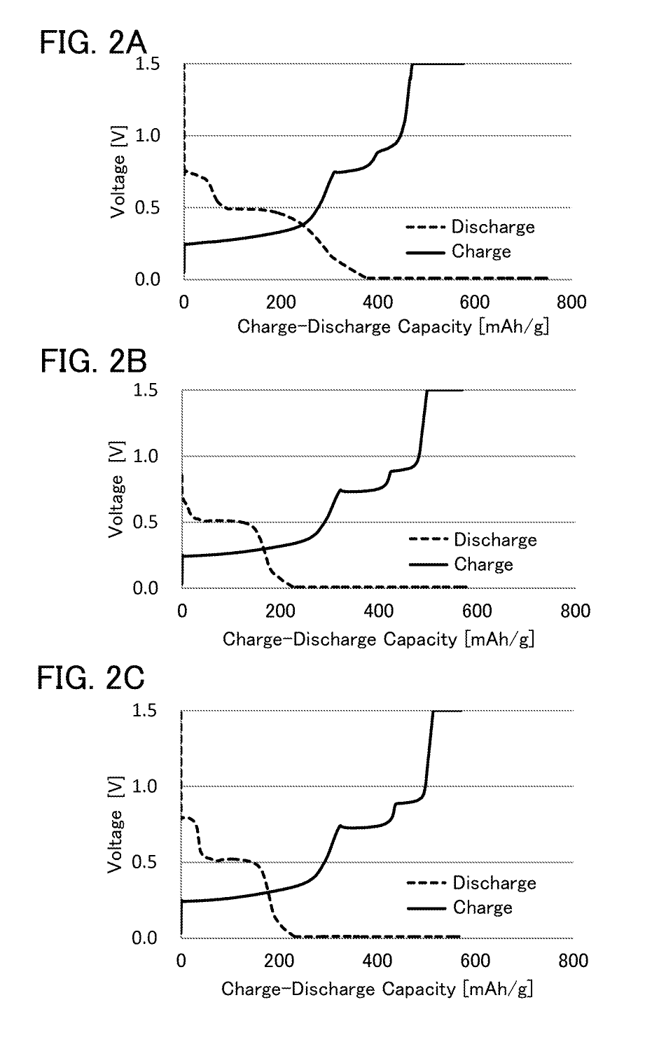

FIGS. 2A to 2C show the charge and discharge characteristics of the half cell at room temperature (25° C.). Charge is performed at a rate of 0.1 C, a constant-voltage state is maintained at 1.5 V in charge, and the charge is terminated when the current value becomes less than 0.01 C. Discharge is performed at a rate of 0.1 C, a constant-voltage state is maintained at 0.01 V in discharge, and the discharge is ended when the current value becomes less than 0.01 C. Note that the horizontal axis represents capacity (mAh/g). Note that 1 C means the amount of current per unit weight for fully charging a battery (each evaluation cell, here) in an hour. In this specification, when LiFePO₄ is used for the positive electrode of the battery and the theoretical capacity of the LiFePO₄ is 170 mAh/g, a charging current of 170 mA is 1 C (170 mA/g) assuming that the weight of the LiFePO₄ as the positive electrode is 1 g. In this case, an ideal battery is fully charged in an hour.

In FIG. 2A, two respective curves represent first charge and first discharge.

In FIG. 2B, two respective curves represent second charge and second discharge. The charge and discharge curves of the first charge-discharge cycle are little different from those of the second charge-discharge cycle.

In FIG. 2C, two respective curves represent third charge and third discharge. The charge and discharge curves of the second charge-discharge cycle are little different from those of the third charge-discharge cycle.

Owing to high initial charge and discharge efficiency, capacity loss is low. Moreover, the charge and discharge efficiency in the second and third cycles is high.

Initial charge and discharge efficiency refers to the ratio of initial discharge capacity to initial charge capacity. Initial discharge capacity refers to discharge capacity in the initial charge and discharge cycle. Initial charge and discharge efficiency (%) is the proportion of electric power capacity (Ahr) at the time of discharge to electric power capacity at the time of charge. Here, initial charge and discharge efficiency is calculated from the charge and discharge curves obtained in the case where constant current discharge is performed until the voltage falls to 0.01 V, the constant-voltage state is maintained at 0.01 V until the current value becomes less than 0.01 C, the half cell is left in the open-circuit state for an hour, and then the half cell is discharged.

From a practical point of view, the initial charge and discharge efficiency of lithium-ion secondary batteries is required to be higher than or equal to 90%.

### Embodiment 2

In this embodiment, the structure of a storage battery including the negative electrode fabricated by the fabricating method described in Embodiment 1 will be described with reference to FIGS. 5A to 5C, FIG. 6, and FIGS. 7A and 7B.

### (Coin-Type Storage Battery)

FIG. 5A is an external view of a coin-type (single-layer flat type) storage battery, and FIG. 5B is a cross-sectional view thereof.

In a coin-type storage battery 300, the positive electrode can 301 doubling as a positive electrode terminal and the negative electrode can 302 doubling as a negative electrode terminal are insulated from each other and sealed by a gasket 303 made of polypropylene or the like. A positive electrode 304 includes a positive electrode current collector 305 and a positive electrode active material layer 306 provided in contact with the positive electrode current collector 305. The positive electrode active material layer 306 may further include a binder for increasing adhesion of positive electrode active materials, a conductive additive for increasing the conductivity of the positive electrode active material layer, and the like in addition to the active materials. As the conductive additive, a material that has a large specific surface area is preferably used; for example, acetylene black (AB) can be used. Alternatively, a carbon material such as a carbon nanotube, graphene, or fullerene can be used.

A negative electrode 307 includes a negative electrode current collector 308 and a negative electrode active material layer 309 provided in contact with the negative electrode current collector 308. The negative electrode active material layer 309 may further include a binder for increasing adhesion of negative electrode active materials, a conductive additive for increasing the conductivity of the negative electrode active material layer, and the like in addition to the negative electrode active materials. The separator 310 and an electrolyte (not illustrated) are provided between the positive electrode active material layer 306 and the negative electrode active material layer 309.

Gallium given in Embodiment 1 is used as a negative electrode active material in the negative electrode active material layer 309.

The current collectors 305 and 308 can each be formed using a highly conductive material which is not alloyed with a carrier ion of lithium among other elements, such as a metal typified by stainless steel, gold, platinum, zinc, iron, nickel, copper, aluminum, titanium, and tantalum or an alloy thereof. Alternatively, an aluminum alloy to which an element which improves heat resistance, such as silicon, titanium, neodymium, scandium, and molybdenum, is added can be used. Still alternatively, a metal element which forms silicide by reacting with silicon can be used. Examples of the metal element which forms silicide by reacting with silicon include zirconium, titanium, hafnium, vanadium, niobium, tantalum, chromium, molybdenum, tungsten, cobalt, nickel, and the like. The current collectors can each have a foil-like shape, a plate-like shape (sheet-like shape), a net-like shape, a cylindrical shape, a coil shape, a punching-metal shape, an expanded-metal shape, or the like as appropriate. The current collectors each preferably have a thickness of 10 μm to 30 μm inclusive.

For the positive electrode active material layer 306, a material into/from which lithium ions can be inserted and extracted can be used. For example, a material with an olivine crystal structure, a layered rock-salt crystal structure, or a spinel crystal structure can be used. As the positive electrode active material, a compound such as LiFeO₂, LiCoO₂, LiNiO₂, LiMn₂O₄, V₂O₅, Cr₂O₅, or MnO₂ can be used.

Typical examples of a lithium-containing material represented by a general formula LiMPO₄ (M is one or more of Fe(II), Mn(II), Co(II), and Ni(II)) include LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFe_{f}Ni_{g}CoₕMnᵢPO₄ (f+g+h+i≦1, 0<f≦1, 0<g<1, 0<h<1, and 0<i<1).

Examples of a lithium-containing material with a layered rock-salt crystal structure include lithium cobalt oxide (LiCoO₂); LiNiO₂; LiMnO₂; Li₂MnO₃; an NiCo-based lithium-containing material (a general formula thereof is LiNiₓCo₁₋ₓO₂ (0<x<1)) such as or LiNi_{0.8}Co_{0.2}O₂; an NiMn-based lithium-containing material (a general formula thereof is LiNiₓMn₁₋ₓO₂ (0<x<1)) such as LiNi_{0.5}Mn_{0.5}O₂; an NiMnCo-based lithium-containing material (also referred to as NMC, and a general formula thereof is LiNiₓMn_{y}Co_{1-x-y}O₂ (x>0, y>0, x+y<1)) such as LiNi_{1/3}Mn_{1/3}Co_{1/3}O₂; Li(Ni_{0.8}Co_{0.15}Al_{0.05})O₂; and Li₂MnO₃—LiMO₂ (M=Co, Ni, or Mn).

Examples of a lithium-containing compound with a spinel crystal structure include LiMn₂O₄, Li₁₊ₓMn₂₋ₓO₄, Li(MnAl)₂O₄, and LiMn_{1.5}Ni_{0.5}O₄.

It is preferable to add a small amount of lithium nickel oxide (LiNiO₂ or LiNi₁₋ₓMO₂ (M=Co, Al, or the like)) to a lithium-containing material with a spinel crystal structure which contains manganese, such as LiMn₂O₄, in which case advantages such as inhibition of the elution of manganese and the decomposition of an electrolytic solution can be obtained.

Alternatively, a lithium-containing material such as Li₍₂₋ⱼ₎MSiO₄ (general formula) (M is one or more of Fe(II), Mn(II), Co(II), and Ni(II), 0≦j≦2) can be used for the positive electrode active material. Typical examples of Li₍₂₋ⱼ₎MSiO₄ (general formula) are lithium compounds such as Li₍₂₋ⱼ₎FeSiO₄, Li₍₂₋ⱼ₎NiSiO₄, Li₍₂₋ⱼ₎CoSiO₄, Li₍₂₋ⱼ₎MnSiO₄, Li₍₂₋ⱼ₎FeₖNiₗSiO₄, Li₍₂₋ⱼ₎FeₖCoₗSiO₄, Li₍₂₋ⱼ₎FeₖMnᵢSiO₄, Li₍₂₋ⱼ₎NiₖCoₗSiO₄, Li₍₂₋ⱼ₎NiₖMnₗSiO₄ (k+l≦1, 0<k<1, and 0<l<1), Li₍₂₋ⱼ₎FeₘNiₙCo_{q}SiO₄, Li₍₂₋ⱼ₎FeₘNiₙMn_{q}SiO₄, Li₍₂₋ⱼ₎NiₘCoₙMn_{q}SiO₄ (m+n+q≦1, 0<m<1, 0<n<1, and 0<q<1), and Li₍₂₋ⱼ₎FeᵣNiₛCoₜMnᵤSiO₄ (r+s+t+u≦1, 0<r<1, 0<s<1, 0<t<1, and 0<u<1).

Still alternatively, a nasicon compound expressed by AₓM₂(XO₄)₃ (general formula) (A=Li, Na, or Mg, M=Fe, Mn, Ti, V, Nb, or Al, X═S, P, Mo, W, As, or Si) can be used for the positive electrode active material. Examples of the nasicon compound are Fe₂(MnO₄)₃, Fe₂(SO₄)₃, and Li₃Fe₂(PO₄)₃. Further alternatively, a compound expressed by Li₂MPO₄F, Li₂MP₂O₇, or Li₅MO₄ (general formula) (M=Fe or Mn), a perovskite fluoride such as NaF₃ or FeF₃, a metal chalcogenide (a sulfide, a selenide, or a telluride) such as TiS₂ or MoS₂, a lithium-containing material with an inverse spinel crystal structure such as LiMVO₄, a vanadium oxide (V₂O₅, V₆O₁₃, LiV₃O₈, or the like), a manganese oxide, an organic sulfur, or the like can be used as the positive electrode active material.

As the separator 310, an insulator such as cellulose (paper), polyethylene with pores, and polypropylene with pores can be used.

As an electrolyte in the electrolytic solution, a material which contains carrier ions is used. Typical examples of the electrolyte are lithium salts such as LiPF₆, LiClO₄, LiAsF₆, LiBF₄, LiCF₃SO₃, Li(CF₃SO₂)₂N, and Li(C₂F₅SO₂)₂N. One of these electrolytes may be used alone, or two or more of them may be used in an appropriate combination and in an appropriate ratio.

Note that when carrier ions are alkali metal ions other than lithium ions, alkaline-earth metal ions, beryllium ions, or magnesium ions, instead of lithium in the above lithium salts, an alkali metal (e.g., sodium and potassium), an alkaline-earth metal (e.g., calcium, strontium, barium, beryllium, and magnesium) may be used for the electrolyte.

As a solvent of the electrolytic solution, a material in which carrier ions can transfer is used. As the solvent of the electrolytic solution, an aprotic organic solvent is preferably used. Typical examples of aprotic organic solvents include EC, propylene carbonate, DEC, γ-butyrolactone, acetonitrile, dimethoxyethane, tetrahydrofuran, and the like, and one or more of these materials can be used. When a gelled high-molecular material is used as the solvent of the electrolytic solution, safety against liquid leakage and the like is improved. Furthermore, the storage battery can be thinner and more lightweight. Typical examples of gelled high-molecular materials include a silicone gel, an acrylic gel, an acrylonitrile gel, polyethylene oxide, polypropylene oxide, a fluorine-based polymer, and the like. Alternatively, the use of one or more of ionic liquids (room temperature molten salts) which have features of non-flammability and non-volatility as a solvent of the electrolytic solution can prevent the storage battery from exploding or catching fire even when the storage battery internally shorts out or the internal temperature increases owing to overcharging and others.

Instead of the electrolytic solution, a solid electrolyte including an inorganic material such as a sulfide-based inorganic material or an oxide-based inorganic material, or a solid electrolyte including a macromolecular material such as a polyethylene oxide (PEO)-based macromolecular material may alternatively be used. When the solid electrolyte is used, a separator and a spacer are not necessary. Furthermore, the battery can be entirely solidified; therefore, there is no possibility of liquid leakage and thus the safety of the battery is dramatically increased.

For the positive electrode can 301 and the negative electrode can 302, a metal having a corrosion-resistant property to an electrolytic solution in charging and discharging a secondary battery, such as nickel, aluminum, and titanium, an alloy of any of the metals, an alloy containing any of the metals and another metal (e.g., stainless steel), a stack of any of the metals, a stack including any of the metals and any of the alloys (e.g., a stack of stainless steel and aluminum), or a stack including any of the metals and another metal (e.g., a stack of nickel, iron, and nickel) can be used. The positive electrode can 301 and the negative electrode can 302 are electrically connected to the positive electrode 304 and the negative electrode 307, respectively.

The negative electrode 307, the positive electrode 304, and the separator 310 are immersed in the electrolytic solution. Then, as illustrated in FIG. 5B, the positive electrode 304, the separator 310, the negative electrode 307, and the negative electrode can 302 are stacked in this order with the positive electrode can 301 positioned at the bottom, and the positive electrode can 301 and the negative electrode can 302 are subjected to pressure bonding with the gasket 303 interposed therebetween. In such a manner, the coin-type storage battery 300 can be manufactured.

FIG. 5C is a cross-sectional view of a storage battery 400. The negative electrode 404 includes a negative electrode current collector and a negative electrode active material layer in contact with the negative electrode current collector. The negative electrode active material layer faces a positive electrode active material layer, and an electrolytic solution 406 and a separator 408 are provided between the positive electrode active material layer and the negative electrode active material layer. Here, a current flow in charging a battery will be described with reference to FIG. 5C. When a battery using lithium is regarded as a closed circuit, lithium ions transfer and a current flows in the same direction. Note that in the battery using lithium, an anode and a cathode change places in charge and discharge, and an oxidation reaction and a reduction reaction occur on the corresponding sides; hence, an electrode with a high redox potential is called a positive electrode and an electrode with a low redox potential is called a negative electrode. For this reason, in this specification, the positive electrode is referred to as a “positive electrode” and the negative electrode is referred to as a “negative electrode” in all the cases where charge is performed, discharge is performed, a reverse pulse current is supplied, and a charging current is supplied. The use of the terms “anode” and “cathode” related to an oxidation reaction and a reduction reaction might cause confusion because the anode and the cathode change places at the time of charging and discharging. Thus, the terms “anode” and “cathode” are not used in this specification. If the terms “anode” or “cathode” is used, it should be mentioned that the anode or the cathode is which of the one at the time of charging or the one at the time of discharging and corresponds to which of a positive electrode or a negative electrode.

Two terminals in FIG. 5C are connected to a charger, and a storage battery 400 is charged. As the charge of the storage battery 400 proceeds, a potential difference between electrodes increases. The positive direction in FIG. 5C is the direction in which a current flows from one terminal outside the storage battery 400 to a positive electrode 402, flows from the positive electrode 402 to a negative electrode 404 in the storage battery 400, and flows from the negative electrode 404 to the other terminal outside the storage battery 400. In other words, a current flows in the direction of a flow of a charging current.

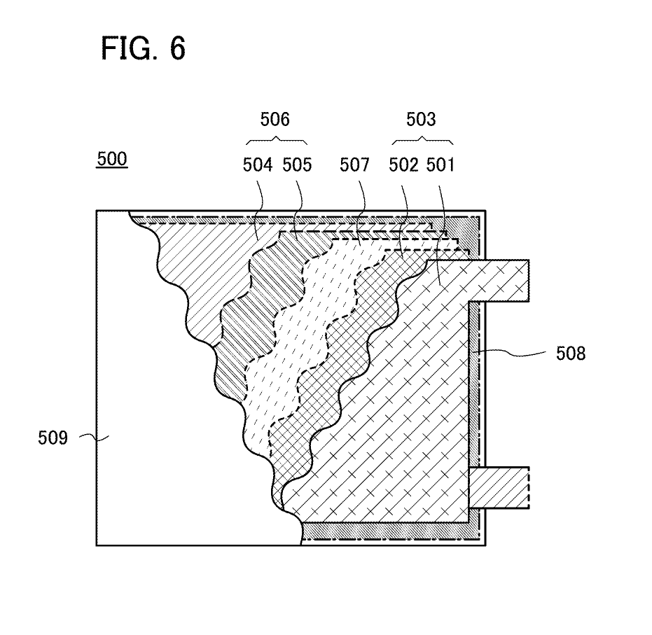

Next, an example of a laminated storage battery will be described with reference to FIG. 6.

A laminated storage battery 500 illustrated in FIG. 6 includes a positive electrode 503 including a positive electrode current collector 501 and a positive electrode active material layer 502, a negative electrode 506 including a negative electrode current collector 504 and a negative electrode active material layer 505, a separator 507, an electrolytic solution 508, and an exterior body 509. The separator 507 is provided between the positive electrode 503 and the negative electrode 506, and they are sealed with the exterior body 509. Furthermore, the electrolytic solution 508 is contained in a region enclosed by the exterior body 509.

In the laminated storage battery 500 illustrated in FIG. 6, the positive electrode current collector 501 and the negative electrode current collector 504 also serve as terminals for an electrical contact with an external portion. For this reason, each of the positive electrode current collector 501 and the negative electrode current collector 504 is arranged so that part of the positive electrode current collector 501 and part of the negative electrode current collector 504 are exposed on the outside the exterior body 509.

As the exterior body 509 in the laminated storage battery 500, for example, a laminate film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film can be used. With such a three-layer structure, permeation of the electrolytic solution and a gas can be blocked and an insulating property can be obtained.

### <Cylindrical Storage Battery>

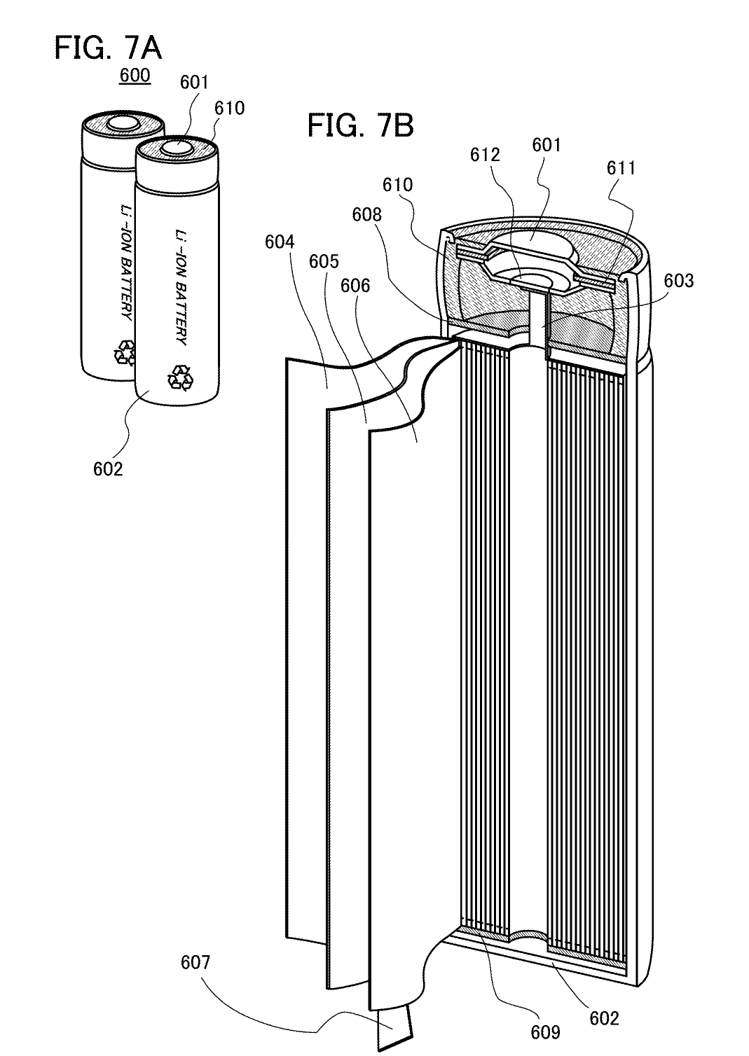

Next, an example of a cylindrical storage battery will be described with reference to FIGS. 7A and 7B. As illustrated in FIG. 7A, a cylindrical storage battery 600 includes a positive electrode cap (battery cap) 601 on the top surface and a battery can (outer can) 602 on the side surface and bottom surface. The positive electrode cap 601 and the battery can 602 are insulated from each other by a gasket (insulating gasket) 610.

FIG. 7B is a diagram schematically illustrating a cross section of the cylindrical storage battery. Inside the battery can 602 having a hollow cylindrical shape, a battery element in which a strip-like positive electrode 604 and a strip-like negative electrode 606 are wound with a stripe-like separator 605 interposed therebetween is provided. Although not illustrated, the battery element is wound around a center pin. For the battery can 602, a metal having corrosion resistance to an electrolytic solution, such as nickel, aluminum, or titanium, an alloy of such a metal, or an alloy of such a metal and another metal (e.g., stainless steel) can be used. Alternatively, the battery can 602 is preferably covered with nickel, aluminum, or the like in order to prevent corrosion caused by a nonaqueous electrolytic solution. Inside the battery can 602, the battery element in which the positive electrode, the negative electrode, and the separator are wound is provided between a pair of insulating plates 608 and 609 which face each other. Inside the battery can 602, the battery element in which the positive electrode, the negative electrode, and the separator are wound is interposed between a pair of insulating plates 608 and 609 which face each other. Furthermore, a nonaqueous electrolytic solution (not illustrated) is injected inside the battery can 602 provided with the battery element. As the nonaqueous electrolytic solution, a nonaqueous electrolytic solution which is similar to those of the above coin-type storage battery and the laminated power storage device can be used.

Although the positive electrode 604 and the negative electrode 606 can be formed in a manner similar to that of the positive electrode and the negative electrode of the coin-type storage battery described above, the difference lies in that, since the positive electrode and the negative electrode of the cylindrical storage battery are wound, active materials are formed on both sides of the current collectors. A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 612 and the bottom of the battery can 602, respectively. The safety valve mechanism 612 is electrically connected to the positive electrode cap 601 through a positive temperature coefficient (PTC) element 611. The safety valve mechanism 612 cuts off electrical connection between the positive electrode cap 601 and the positive electrode 604 when the internal pressure of the battery exceeds a predetermined threshold value. The PTC element 611, which serves as a thermally sensitive resistor whose resistance increases as temperature rises, limits the amount of current by increasing the resistance, in order to prevent abnormal heat generation. Note that barium titanate (BaTiO₃)-based semiconductor ceramic can be used for the PTC element.

Note that in this embodiment, the coin-type storage battery, the laminated storage battery, and the cylindrical storage battery are given as examples of the storage battery; however, any of storage batteries with a variety of shapes, such as a sealed storage battery and a square-type storage battery, can be used. Furthermore, a structure in which a plurality of positive electrodes, a plurality of negative electrodes, and a plurality of separators are stacked or wound may be employed.

For each of the negative electrodes of the storage batteries 300, 500, and 600, which are described in this embodiment, a negative electrode fabricated by the method for fabricating a negative electrode of one embodiment of the present invention is used. Thus, the discharge capacity of the storage batteries 300, 500, and 600 can be increased.

This embodiment can be implemented in combination with Embodiment 1 as appropriate.

This application is based on Japanese Patent Application serial no. 2013-125428 filed with Japan Patent Office on Jun. 14, 2013, the entire contents of which are hereby incorporated by reference.

What is claimed is:

1. A negative electrode of a secondary battery comprising:
a current collector; and
a negative electrode active material layer on the current collector, the negative electrode active material layer comprising gallium and resin.

2. The negative electrode according to claim 1, wherein a proportion of the resin in the negative electrode active material layer is 2 wt % or more.

3. The negative electrode according to claim 1, wherein a proportion of the resin in the negative electrode active material layer is 10 wt % or more.

4. The negative electrode according to claim 1, wherein the resin includes fluorine.

5. The negative electrode according to claim 1, wherein the negative electrode active material layer further comprises a fibrous body.

6. The negative electrode according to claim 5, wherein the fibrous body comprises cellulose fiber.

7. The negative electrode according to claim 5, wherein the fibrous body is impregnated with gallium.

8. A secondary battery comprising:
a positive electrode; and
a negative electrode comprising a current collector and a negative electrode active material layer,
wherein the negative electrode active material layer comprises gallium and resin.

9. The secondary battery according to claim 8, wherein a proportion of the resin in the negative electrode active material layer is 2 wt % or more.

10. The secondary battery according to claim 8, wherein a proportion of the resin in the negative electrode active material layer is 10 wt % or more.

11. The secondary battery according to claim 8, wherein the resin includes fluorine.

12. A secondary battery comprising:
a positive electrode; and
a negative electrode comprising a current collector and a negative electrode active material layer,
wherein the negative electrode active material layer comprises gallium, resin, and a fibrous body.

13. The secondary battery according to claim 12, wherein a proportion of the resin in the negative electrode active material layer is 2 wt % or more.

14. The secondary battery according to claim 12, wherein a proportion of the resin in the negative electrode active material layer is 10 wt % or more.

15. The secondary battery according to claim 12, wherein the resin includes fluorine.

16. The secondary battery according to claim 12, wherein the fibrous body comprises cellulose fiber.

17. The secondary battery according to claim 12, wherein the fibrous body is impregnated with gallium.
